(19) United States
(12) Patent Application Publication
(10) Pub. No.: US 2006/0187067 A1
(43) Pub. Date: Aug. 24, 2006

(54) Instantaneous sleep activated alarm

(76) Inventor: William A. Simpson, Reseda, CA (US)

Correspondence Address: William A. Simpson, 7241 Yolanda Ave., Reseda, CA, 91335, US

(21) Appl. No.: 10/463,938

(22) Filed: Jun. 18, 2003

Related U.S. Application Data
(60) Provisional application No. 60/403,230, filed on Aug. 14, 2002.

(51) Int. Cl. G08B 23/00

(52) U.S. Cl. 340/576

(57) ABSTRACT

This invention continuously monitors the position of a drivers head. This invention will instantly sound an alarm when a drivers head falls forward and downward should the driver fall asleep at the wheel.

### BACKGROUND OF THE INVENTION

1. Field of Invention

This invention relates to highway safety. The focus of this invention is on accidents in which a driver has apparently fallen asleep at the wheel.

2. Description of the Related Art

Several patents describe eye and hand activated sleep prevention devices. This invention describes an anti-sleep device actuated by a drivers' nodding head as the driver falls asleep at the wheel.

### BRIEF SUMMARY OF THE INVENTION

This invention utilizes an electrical switch placed between a drivers head and the vehicle. The switch will be activated as the drivers head falls forward and downward should the driver fall asleep at the wheel.

Depending on the switch location option used the switch may be:
1. a bar switch which will close as the drivers forehead contacts it.
2. a liquid or gas filled tube to operate a pressure switch as the drivers forehead falls against the tube.
3. a proximity switch used to detect the drivers head as the drivers head approaches or moves away from the proximity switch.
4. an electromagnetic beam switch to detect when the drivers head interrupts the beam or when the drivers head moves out of the beam.

For the purpose of this application, only the electromagnetic beam device will be described in detail. This will then provide for an understanding of the operation of the other switching options.

The beam generator and the photodiode are mounted on a structure secured to the top of a vehicle. In this manner a beam can be placed in any one of three locations:
1. Behind the drivers head.
2. Under the drivers chin.
3. In front of the drivers' forehead.

As the driver falls asleep at the wheel the drivers head will interact with the beam as follows:
1. A beam placed behind the drivers head. The drivers head will no longer interrupt the beam and the beam will strike the photodiode.
2. A beam placed under the chin of the driver. The drivers chin will interrupt the beam and the beam will no longer strike the photodiode.
3. A beam placed in front of the drivers forehead. The drivers forehead will interrupt the beam and the beam will no longer strike the photodiode.

In situation 1, the beam will be held in place by a device attached to the headrest.

In situation 2, the beam will be held in place by a device attached to the seat.

In situation 3, the beam will be held in place by a device attached to the vehicles top. An ordinary car visor seems to be well suited to accomplish this.

Situation 3 is described in some detail along with drawings.

### BRIEF DESCRIPTION OF THE DRAWINGS

FIG. 1 numerical designations.
1. Car visor (adjustable beam support).
2. Beam generator.
3. Beam.
4. Photodiode.
5. Module, comprising:
   6. Transmitter.
   7. Relay (normally closed).
   8. Battery switch.
   9. Battery switch indicator lamp.

FIG. 2 shows a circuit diagram.

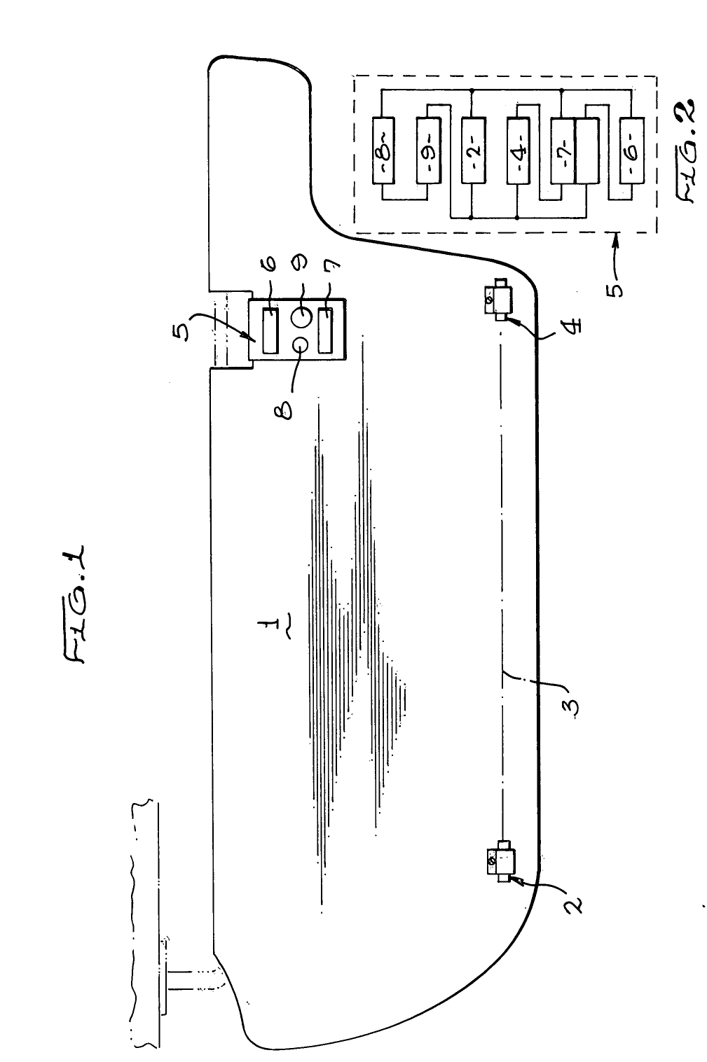

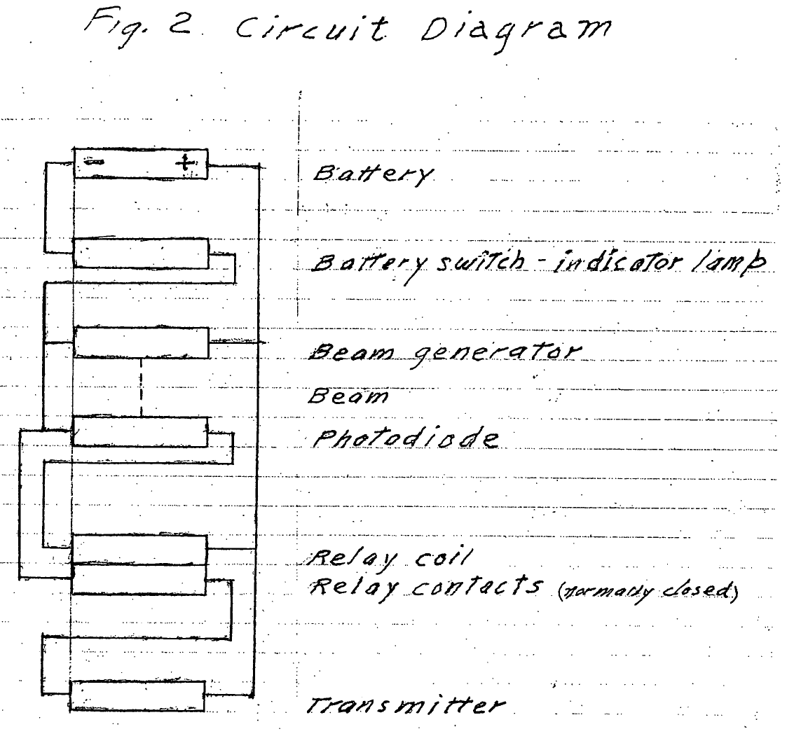

### DETAILED DESCRIPTION OF THE INVENTION

The device attached to the top of the vehicle and used to place the beam in front of the drivers forehead must provide for minor adjustments to suit the driver.

This device must also provide for moving the equipment away from the driver and placing it up against the top of the vehicle when the beam is not in use.

To accomplish this a device similar to an ordinary automobile visor is used.

The beam generator 2 is secured to the lower left corner of the visor 1. The photodiode 4 is secured to the lower right corner of the visor 1. A beam 3 is then projected across the visor 1 near the lower edge so that the beam 3 will be interrupted should the driver “nod off” and fall asleep at the wheel.

By adjusting the visor 1 in a normal manner, the beam 3 can be placed in the desired location with respect to the drivers forehead.

The desired location of the beam 3 is as follows:
1. In front of the drivers forehead and far enough away to permit any movement of the drivers head necessary during the operation of the vehicle.
2. Yet close enough to the drivers forehead so that the beam 3 will be interrupted should the driver “nod off” and fall asleep at the wheel.

The module 5 is placed on the visor 1. The module 5 is comprised of the following:
A. transmitter 6.
B. relay (normally closed) 7.
C. Battery switch 8.
D. Battery switch indicator lamp 9.

The operation is as follows:
As the driver “nods off” and falls asleep at the wheel the drivers forehead will interrupt the beam 3.
The current through the photodiode 4 will be reduced.
The current through the relay (normally closed) 7 will be reduced and the relay contacts will close.
The transmitter 6 will be energized and will transmit to a remote receiver (not shown) a few feet away. The alarm (not shown) will sound to awaken the driver.

1. An instantaneous sleep activated alarm, comprising:
a. an electrical switch placed between the interior of a vehicle and the drivers head so that when said drivers head falls forward and downward during initial sleep said drivers head will actuate said switch,
b. an alarm connected to said switch to sound when said drivers head actuates said switch.
c. means for providing electrical energy to said switch and said alarm.
Whereby said driver will be awakened by said alarm as said drivers head falls forward and downward while falling asleep at the wheel.
